(19) United States
(12) Patent Application Publication
(10) Pub. No.: US 2013/0311770 A1
(43) Pub. Date: Nov. 21, 2013

(54) TRACING DEVICE AND METHOD

(71) Applicant: Nicolas Reffe, Montpellier (FR)

(72) Inventor: Nicolas Reffe, Montpellier (FR)

(73) Assignee: ORIDAO, MONTPELLIER (FR)

(21) Appl. No.: 13/978,212

(22) PCT Filed: Dec. 13, 2011
(86) PCT No.: PCT/FR11/52968

§ 371 Date: Aug. 1, 2013

(30) Foreign Application Priority Data
Jan. 7, 2011 (FR) 1150121

(51) Int. Cl. H04L 9/32

(52) U.S. Cl. CPC H04L 9/321
USPC 713/155

(57) ABSTRACT

A tracing method performed by a traceability device for validating a process having a purity of steps. During at least one step of the process, there is a step of receiving a marking message sent by a marking device; and a step of determining a new fingerprint as a function of the marking message and of a preceding fingerprint, by using a hash function; and a step of sending a validation message including the most recently determined new fingerprint to a validation device. During at least one step of the process, there is a step of determining an object signature as a function of the marking message by using an asymmetric signature function and a private key of the traceability device associated with a public key of the traceability device, and a step of determining a new fingerprint as a function of the object signature.

### BACKGROUND OF THE INVENTION

The present invention relates to the general field of the traceability of arbitrary objects such as, for example: materials, products, or devices.

The invention relates more particularly to mechanisms making it possible, at any stage in a process made up of a plurality of steps, to monitor whether an object that has reached this stage has indeed been subjected to all of the steps provided for in the process and in a predetermined order. In the meaning of the invention, a step to which an object is subjected may refer in particular to any kind of processing applied to the object or to a state or a change of state of some physical parameter of the object (for example its temperature, pressure, etc.).

Document FR 2 933 216 describes a method and a system for validating a succession of events to which a device is subjected. The device being tracked incorporates or carries a traceability device constituted for example by a radio frequency identity (RFID) chip. Initially, an initial fingerprint E₀ is calculated, in particular as a function of a secret referred to as a proprietor code K in that document. Thereafter, on each event, a fingerprint Eₙ is calculated and stored in the RFID chip as a function of the preceding fingerprint Eₙ₋₁. In order to validate the succession of events, the last fingerprint Eₙ stored in the RFID chip is transmitted to a validation device that calculates a theoretical fingerprint and compares it with the received fingerprint. The theoretical fingerprint is calculated iteratively by calculating the succession of fingerprints that ought normally to have been calculated by the RFID chip, starting from the initial fingerprint.

Although effective and reliable, that method is limited by characteristics that are specific to symmetric cryptography, namely sharing a secret: the validation device needs to know the proprietor code K in order to be able to determine the theoretical fingerprint.

Furthermore, the proprietor code K must be distributed in secret manner in order to ensure that no third party can analyze the fingerprint Eₙ as transmitted by an RFID chip.

Thus, only the holders of appropriate keys are in a position to verify locally that the life cycles to which the products have been subjected are authentic, with the constraints associated with distributing and storing such keys in secure manner. A non-authorized user may naturally send a request to an authorized server associating the current fingerprint of the object and the life cycle as stored in the object, but such a request is impossible when there are no means for communicating with that server.

### OBJECT AND BRIEF SUMMARY OF THE INVENTION

The present invention seeks to mitigate those drawbacks.

To this end, the invention relates to a tracing method performed by a traceability device for validating a process made up of a plurality of steps, the tracing method comprising:
during at least one step of the process:
   a step of receiving a marking message sent by a marking device; and
   a step of determining a new fingerprint as a function of the marking message and of a preceding fingerprint, by using a hash function; and
a step of sending a validation message including the most recently determined new fingerprint to a validation device.

This tracing method is remarkable in that during said at least one step of the process, it comprises a step of determining an object signature as a function of the marking message by using an asymmetric signature function and a private key of the traceability device associated with a public key of the traceability device, with the step of determining a new fingerprint comprising determining the new fingerprint as a function of the object signature.

Correspondingly, the invention provides a traceability device for validating a process made up of a plurality of steps, the traceability device comprising:
means for receiving a marking message sent by a marking device during at least one step of the process;
means for determining a new fingerprint as a function of the marking message and of a preceding fingerprint by using a hash function during at least one step of the process; and
means for sending a validation message including the most recently determined new fingerprint to a validation device.

The traceability device is remarkable in that it comprises means for determining an object signature as a function of the marking message during at least one step of the process, by using an asymmetric signature function and a private key of the traceability device associated with a public key of the traceability device, the means for determining a new fingerprint being configured to determine the new fingerprint as a function of said object signature.

In corresponding manner, the invention provides a validation method performed by a validation device for validating a process made up of a plurality of steps, the validation method comprising:
a step of receiving a validation message sent by a traceability device, and including a fingerprint determined by the traceability device;
a step of determining a theoretical fingerprint; and
a step of comparing the fingerprint determined by the traceability device with the theoretical fingerprint.

The validation method is remarkable in that the validation message comprises an object signature for at least one step of the process, the validation method including a step of verifying the authenticity of the object signature as a function of a public key of the traceability device, and the step of determining a theoretical fingerprint comprising, when the object signature is authentic, determining a new current theoretical fingerprint as a function of a preceding theoretical fingerprint and of said object signature.

Correspondingly, the invention provides a validation device for validating a process made up of a plurality of steps, the validation device comprising:
means for receiving a validation message sent by a traceability device and including a fingerprint determined by the traceability device;
means for determining a theoretical fingerprint; and
means for comparing the fingerprint determined by the traceability device with the theoretical fingerprint.

The validation device is remarkable in that the validation message includes an object signature for at least one step of the process, the validation device including means for verifying the authenticity of the object signature as a function of a public key of the traceability device, the means for determining a theoretical fingerprint being configured, when said object signature is authentic, to determine a new current theoretical fingerprint as a function of a preceding theoretical fingerprint and of said object signature.

Thus, by the traceability device calculating successive fingerprints, and by the validation device calculating a theoretical fingerprint, the invention makes it possible to implement a cryptographic chain that guarantees the integrity of the chain of process steps to which an object carrying or incorporating the traceability device has been subjected, providing the last fingerprint of the traceability device matches the theoretical fingerprint. The traceability device stores all of the information needed by any validation device capable of authenticating the object signature by means of an asymmetric key mechanism in order to verify locally that the steps of the process have been properly chained. The validation device does not need to know the private key of the traceability device. By making use of an asymmetric key mechanism, the invention serves to avoid the difficulties associated with distributing symmetric private keys.

The invention also provides a marking method performed by a marking device associated with a step of a process made up of a plurality of steps, the marking method including a step of sending a marking message to a traceability device, the method being characterized in that it includes a step of determining a step signature by using an asymmetric signature function and a private key of the marking device associated with a public key of the marking device, and the marking message including the step signature.

Correspondingly, the invention provides a marking device associated with a step of a process made up of a plurality of steps, the marking device including means for sending a marking message to a traceability device, and being characterized in that it includes means for determining a step signature by using an asymmetric signature function and a private key of the marking device associated with a public key of the marking device, the marking message including the step signature.

In corresponding manner, in an implementation of the validation method, the validation message includes a step public key associated with a marking device and a step public key signature, the validation method including a step of verifying the authenticity of said step public key.

In corresponding manner, in an implementation of the tracing method, the marking message comprises a step public key and a signature of said step public key as performed by a trusted entity, the method including a step of storing said step public key and said signature of said step public key, the validation message including said step public key and said signature of said step public key as stored.

Under such circumstances, in an implementation of the validation method, the validation message includes a step signature for at least one step of the process; the validation method including a step of verifying the authenticity of said step signature as a function at least of said step public key, and the step of verifying the authenticity of said object signature being performed as a function of said step signature.

Thus, the identity of the marking device can be authenticated. Furthermore, verifying the authenticity of the step signature makes it possible to confirm that the traceability device has interacted effectively with the marking device, and thus that the object has indeed been subjected to the corresponding process step. The traceability device stores all of the information needed to perform these verifications.

In an implementation of the marking method, the marking message includes step data, said step signature being determined as a function at least of the step data.

In corresponding manner, in an implementation of the validation method, the validation message includes step data for at least one step of the process, the step of verifying the authenticity of said step signature being performed as a function of said step data.

Thus, it is possible to verify the authenticity of the data transmitted to the traceability device during a step of the process.

During at least one step of the process, the tracing method may comprise a step of sending an information message including at least a portion of the most recently determined new fingerprint to the marking device;

the marking device being suitable for determining a step signature as a function of said portion by using an asymmetric signature function and a private key of the marking device associated with a public key of the marking device;

said object signature being determined as a function of said step signature.

Under such circumstances, the step of verifying the authenticity of the step signature of the validation method may be performed as a function of at least a portion of the current most recent new theoretical fingerprint.

This makes it possible to strengthen the above-mentioned cryptographic chain.

The tracing method may have an initialization step including determining an initial fingerprint independently of the private key of the traceability device. Correspondingly, the validation method may have an initialization step including determining an initial fingerprint independently of a private key of the traceability device.

By way of example, the initial fingerprint may be received in an initialization message or may be determined as a function of other data received in an initialization message. The transmission of the initialization message does not involve the constraints associated with distributing a symmetric private key.

In an implementation of the validation method, the validation message includes the public key of the traceability device and a signature of the public key of the traceability device as provided by a trusted authority, the validation method including a step of verifying the authenticity of the public key of the traceability device.

This makes it possible to verify the identity of the traceability device.

In a particular implementation, the various steps of the tracing, marking, and/or validation methods are determined by computer program instructions.

Consequently, the invention also provides a computer program on a data medium, the program being suitable for being performed in a computer or the equivalent, the program including instructions adapted to performing steps of a tracing, marking, and/or validation method as described above.

The program may use any programming language and be in the form of source code, object code, or code intermediate between source code and object code, such as in a partially compiled form, or in any other desirable form.

The invention also provides a computer-readable data medium including computer program instructions as mentioned above.

The data medium may be any entity or device capable of storing the program. For example, the medium may comprise storage means such as a read-only memory (ROM), e.g. a compact disk (CD) ROM, or a microelectronic circuit ROM, or indeed magnetic recording means, for example a floppy disk or a hard disk.

Furthermore, the data medium may be a transmissible medium such as an electrical or optical signal that may be conveyed via an electrical or optical cable, by radio, or by other means. The program of the invention may in particular be downloaded from a network of the Internet type.

Alternatively, the data medium may be an integrated circuit in which the program is incorporated, the circuit being adapted to execute or to be used in the execution of the method in question (e.g. an application-specific integrated circuit (ASIC)).

### BRIEF DESCRIPTION OF THE DRAWINGS

The characteristics and advantages of the present invention appear better from the following description made by way of non-limiting indication and with reference to the accompanying drawings, in which:

FIG. 1 is a diagrammatic view illustrating a system in which the invention is performed in accordance with one implementation;

FIG. 2 is a diagrammatic view of the FIG. 1 traceability device;

FIG. 3 is a diagrammatic view of one of the FIG. 1 marking devices;

FIG. 4 shows the interaction between the FIG. 2 traceability device and the FIG. 3 marking device;

FIG. 5 is a diagrammatic view of the FIG. 1 validation device; and

FIG. 6 shows the main steps of a validation method performed by the FIG. 5 validation device.

### DETAILED DESCRIPTION OF AN IMPLEMENTATION OF THE INVENTION

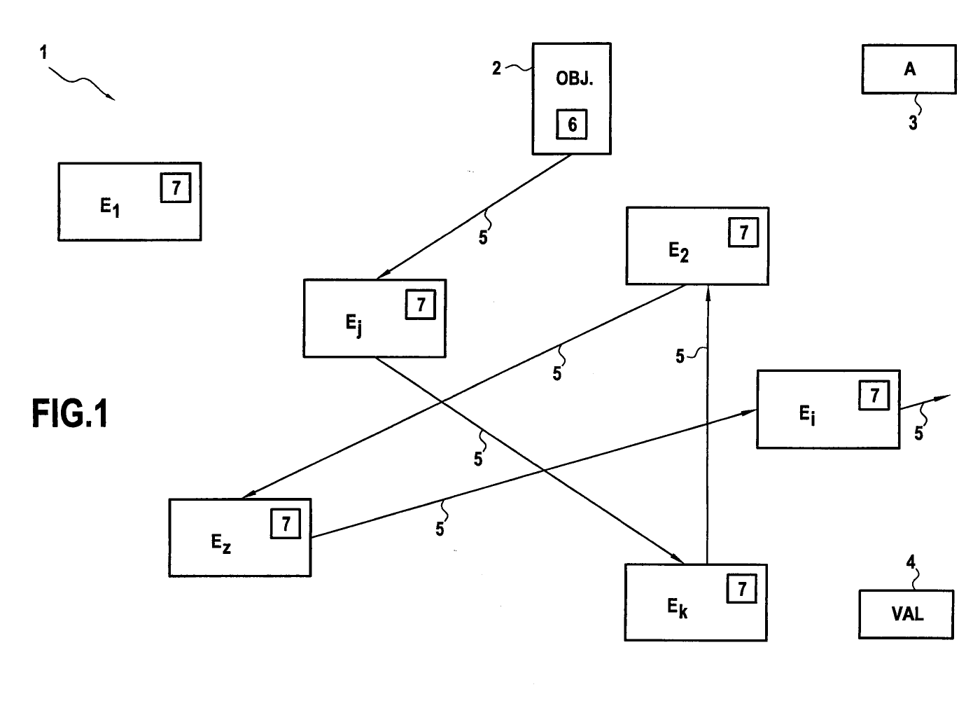

FIG. 1 shows a system 1 in which the invention can be performed. The system 1 comprises an object 2, a plurality of steps E₁, E₂, . . . , Eⱼ, a trusted authority 3, referred to as the authority A, and a validation device 4.

The object 2 carries or incorporates a traceability device 6. The object 2 follows a process made up of a succession of steps from among the steps E₁, E₂, . . . , Eⱼ, as represented by arrows 5 in FIG. 1. At each step Eᵢ of the process, the traceability device 6 interacts with a marking device 7 specific to the step Eᵢ and referenced marking device 7ᵢ. During this interaction, a fingerprint is calculated and stored in the traceability device 6.

During the process or at the end of the process, the validation device 4 can interact with the traceability device 6 in order to validate or invalidate the process followed by the object 2 as a function of the stored fingerprint.

FIG. 1 shows a single object 2. Naturally, when a plurality of objects follow respective processes each made up of a succession of steps from among the steps E₁, E₂, . . . , Eⱼ the system 1 may have a plurality of objects 2, each associated with its own traceability device 6.

Below, there are described in succession the structure of the traceability device 6 and its initialization, the structure of the marking device 7 and its initialization, the interaction between the traceability device 6 and a marking device 7, the structure of the validation device 4 and its initialization, and the interaction between the traceability device 6 and the validation device 4.

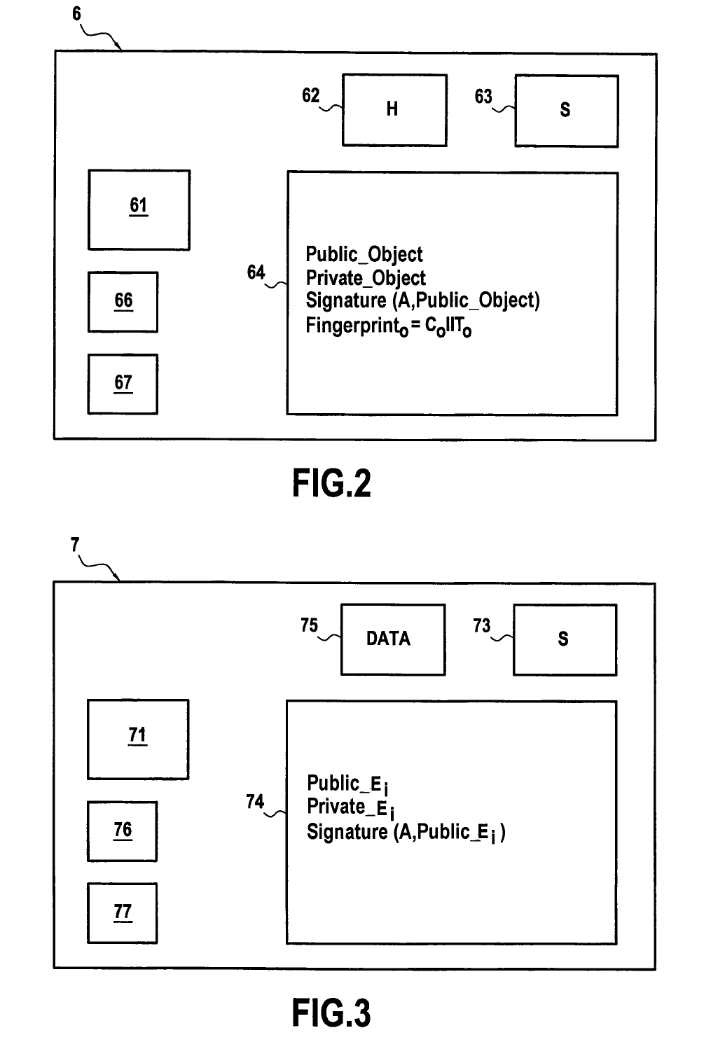

FIG. 2 shows a traceability device 6 in greater detail. The traceability device 6 comprises a communication unit 61, a calculation module 62 for calculating a hash function H, a calculation module 63 for calculating a signature function S, and a non-volatile memory 64.

The traceability device 6 may present the hardware architecture of a computer and may comprise a microprocessor 66 and a volatile memory 67. The overall operation of the traceability device 6 is then determined by a computer program stored in the non-volatile memory 64 and executed by the microprocessor 66 while using the volatile memory 67.

The communication unit 61 enables the traceability device 6 to communicate, in particular with a marking device 7 and with the validation device 4. By way of example, communication may be by way of short-range radio frequency wireless communication. Under such circumstances, the traceability device 6 may be in the form of a RFID chip.

The calculation module 62 implements a cryptographic hash function H. By way of example, this function H is one of the cryptographic hash functions known under the following designations: SHA-1 (secure hash algorithm 1), SHA-2 (secure hash algorithm 2), or MD5 (message digest 5).

The calculation module 63 implements a signature function S that is an asymmetric digital signature algorithm of the DSA, ECDSA, . . . type operating with key pairs comprising a public key and a private key, and using a private key to generate the digital signature of fixed size for data of arbitrary size. Any person holding the public key associated with the private key can verify that the signature has indeed been generated by an entity holding the private key but is not capable of calculating the signature generated using the private key.

The following notation is used below:
Fingerprintₙ=H(Fingerprintₙ₋₁, Data) is the fingerprint calculated by the hash function H as a function of the preceding fingerprint and the data “Data”; and
Signature=Signature(Identity, Data) is the signature calculated by the “Identity” entity using its private key in order to sign the data “Data”.

The calculation modules 62 and 63 may correspond to computer programs stored in the non-volatile memory 64 and capable of being executed by the microprocessor 66. In a variant, the calculation modules 62 and 63 correspond to electronic circuits that are specially designed or configured for the hash function H and for the signature function S.

The non-volatile memory 64 enables data to be stored, in particular data obtained by the communication unit 61 and data calculated by the calculation modules 62 and 63.

While initializing the traceability device 6, i.e. before the beginning of the process made up of steps Eᵢ, the following data is stored in the non-volatile memory 64:
Public_Object, a public key of the traceability device 6 associated with the object 2;
Private_Object, a private key of the traceability device 6 associated with the object 2;
Signature(A, Public_Object), the signature of the key Public_Object by the trusted entity 3; and
Fingerprint₀, the initial value of the fingerprint stored in the traceability device 6. Fingerprint₀ is a value that is known and predetermined. The value Fingerprint₀ may be identical for all of the objects 2 of the system 1. The fingerprint Fingerprint₀ may for example be received in an initialization message or may be determined as a function of other data received in an initialization message.

The keys Public_Object and Private_Object form an asymmetric key pair suitable for use in an asymmetric key cryptographic mechanism.

The fingerprint Fingerprint₀ is made up of two portions of predetermined sizes written C₀ and T₀: Fingerprint₀=C₀∥T₀, where Fingerprint₀, C₀, and T₀ are data in the form of bits and ∥ represents the concatenation operation.

FIG. 3 shows a marking device 7 in greater detail. The index i is used below to designate an element specific to the marking device 7ᵢ of a step Eᵢ.

The marking device 7 comprises a communication unit 71, a calculation module 73 for calculating a signature function S, a non-volatile memory 74, and a data determination module 75. The marking device 7 may present the hardware architecture of a computer and comprise a microprocessor 76 and a volatile memory 77.

The overall operation of the marking device 7 is then determined by a computer program stored in the non-volatile memory 74 and executed by the microprocessor 76 making use of the volatile memory 77.

The communication unit 71 enables the marking device 7 to communicate with the traceability device 6. As explained above, the traceability device 6 may be an RFID chip. Under such circumstances, the communication unit 71 comprises an RFID reader.

The calculation module 73 implements the above-mentioned signature function S.

The data determination module 75 serves to determine data DATA in relation with step Eᵢ. The data DATA may for example be predetermined data or data that depends on the running of the step Eᵢ, for example data giving the value of a parameter.

The calculation module 73 and the data determination module 75 may correspond to computer programs stored in the non-volatile memory 74 and capable of being executed by the microprocessor 76. In a variant, the calculation module 73 and/or the data determination module 75 may correspond to electronics circuits that are specially designed or configured.

The non-volatile memory 74 serves to store data. It may be local or remote and accessible.

During initialization of the marking device 7,, the following data is stored in the non-volatile memory 74:
Public_Eᵢ, a public key of the marking device 7ᵢ associated with the step Eᵢ;
Private_Eᵢ, a private key of the marking device 7ᵢ associated with the step Eᵢ; and
Signature(A, Public_Eᵢ), the signature of the key Public_Eᵢ by the trusted entity 3.

The keys Public_Eᵢ and Private_Eₗ form an asymmetric key pair suitable for use in an asymmetric key cryptographic mechanism.

The public key infrastructure (PKI) mechanisms for managing, distributing, verifying, and revoking asymmetric keys as used during initialization of the traceability device 6 and the marking devices 7 are not described in this document since they constitute the subject matter of an abundant literature known to the person skilled in the art.

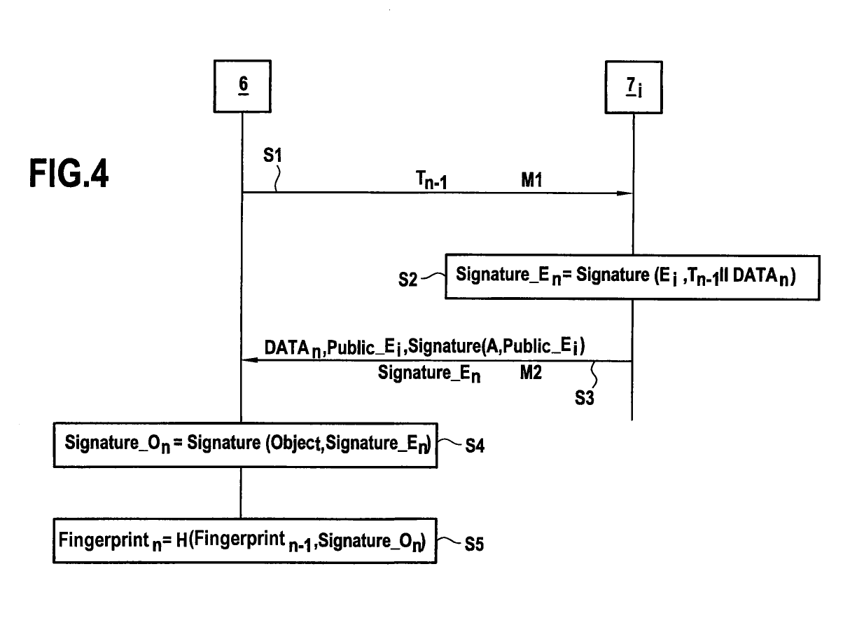

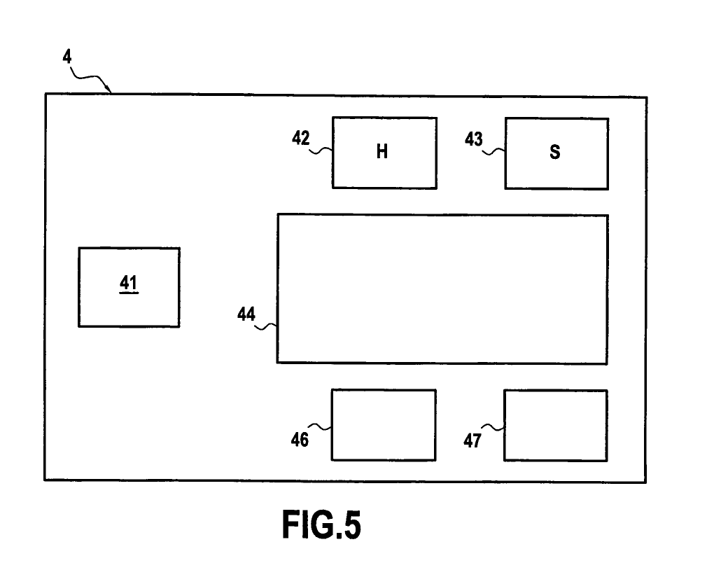

As explained above, at each step Eᵢ of the process, the traceability device 6 interacts with the corresponding marking device 7ᵢ. FIG. 4 shows this interaction in greater detail.

The index n is used, which means that step Eᵢ is the n^{th} step to which the object 2 is subjected. Thus, initially, the fingerprint stored by the traceability device is the fingerprint Fingerprintₙ₋₁.

During step Eᵢ, the traceability device 6 detects the marking device 7ᵢ, e.g. because the step Eᵢ involves placing the object 2 in the proximity of the marking device 7ᵢ, thereby making it possible for the communication units 61 and 71 to detect each other mutually.

When the traceability device 6 detects the marking device 7ᵢ, it extracts the portion Tₙ₋₁from its fingerprint Fingerprintₙ₋₁ and transmits it to the marking device 7ᵢ in an information message M1 (step S1).

In response to receiving Tₙ₋₁, the marking device 7ᵢ signs the data Tₙ₋₁∥DATAₙ, where DATAₙ represents the data determined by the data determination module 75. In other words, the marking device 7ᵢ acts in a step S2 by using the calculation module 73 and its own private key Private_Eᵢ, to determine the step signature Signature_Eₙ:

Signature_{—}Eₙ=Signature(Eᵢ, Tₙ₋₁∥DATAₙ)

Thereafter, in a step S3, the marking device 7ᵢ transmits a marking message M2 to the traceability device 6, the message M2 containing the data DATAₙ, its public key Public_Eᵢ, the signature of its public key Signature(A, Public_Eᵢ), and the step signature Signature_Eₙ.

In response to receiving the marking message M2, the traceability device 6 makes a record n in its non-volatile memory 64 that stores DATAₙ, Public_Eᵢ, Signature(A, Public_Eᵢ), and Signature_Eₙ.

Thereafter, the traceability device 6 signs the step signature Signature_Eₙ (step S4). In other words, the traceability device 6 uses the calculation module 63 and its own private key Private_Object to determine an object signature Signature_Oₙ:

Signature_Oₙ=Signature(Object, Signature_Eₙ)

The object Signature Oₙ is also stored in the record n.

Finally, by using the calculation module 62, the traceability device 6 determines a new fingerprint Fingerprintₙ as a function of the preceding fingerprint Fingerprintₙ₋₁ and the object signature Signature_Oₙ:

Fingerprintₙ=H(Fingerprintₙ₋₁, Signature_Oₙ)

Thus, at the end of the interaction between the traceability device 6 and the marking device 7ᵢ, the non-volatile memory 64 of the traceability device 6 contains:
the keys Public_Object and Private_Object;
the signature Signature (A, Public_Object);
the fingerprint Fingerprintₙ; and
for each of the n steps to which the object 2 has been subjected, a record m for m lying in the range 1 to n, containing: DATAₘ, Public Eᵢ, Signature (A, Public_Eᵢ), Signature_Eₘ, and Signature Oₘ.

This information is used by the validation device 4 to validate or invalidate the succession of steps to which the object 2 has been subjected.

Sending Tₙ₋₁ (step S1), receiving and storing DATAₙ, Public_Eᵢ, Signature (A, Public_Eᵢ), and Signature_Eₙ (step S3), determining and storing Signature_Oₙ (step S4), and determining and storing Fingerprintₙ (step S5) correspond to the main steps of a traceability method performed by the traceability device 6. The traceability method may correspond to instructions of a computer program stored in the non-volatile memory 64.

In similar manner, on receiving Tₙ₋₁ (step S1), determining Signature_Eₙ (step S2), and sending DATAₙ, Public_Eᵢ, Signature (A, Public_Eᵢ), and Signature_Eₙ (step S3), correspond to the main steps of a marking method performed by the marking device 7. This marking method may correspond to instructions of a computer program stored in the non-volatile memory 74.

FIG. 5 shows a validation device 4 in greater detail. The validation device 4 comprises a communication unit 41, a calculation module 42 for calculating a hash function H, a calculation module 43 for calculating a signature S, and a non-volatile memory 44. By way of example, the validation device 4 presents the hardware architecture of a computer and likewise comprises a microprocessor 46 and a volatile memory 47.

The communication unit 41 enables the validation device 4 to communicate with the traceability device 6.

The validation device 4 has access to or has had access to the trusted authority 3, thereby enabling it to verify signatures produced by the trusted authority 3 by making use of the public key Public_A of the trusted entity 3.

Furthermore, the validation device 4 knows the predetermined value Fingerprint₀. The fingerprint Fingerprint₀ may for example be received in an initialization message or it may be determined as a function of other data received in an initialization message.

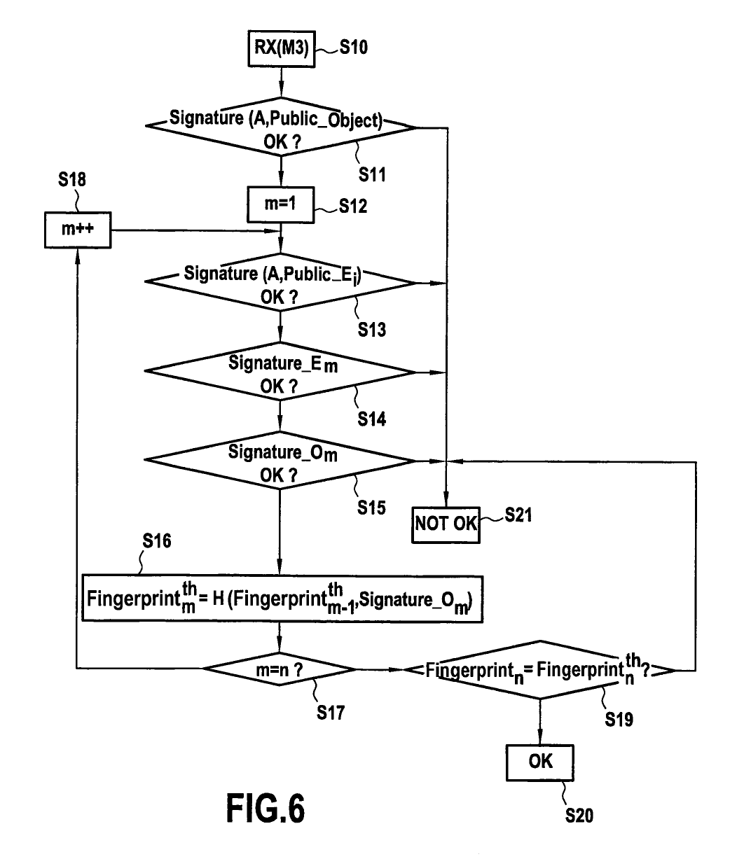

In an embodiment, the validation device 4 is part of a marking device 7. Under such circumstances, the validation and marking device may include in its non-volatile memory both a computer program having instructions for executing a marking method as described above with reference to FIG. 4, and a computer program having instructions for executing a validation method as described below with reference to FIG. 6.

FIG. 6 shows the main steps of a validation method performed by the validation device 4. The steps of FIG. 6 may correspond to the microprocessor 46 executing a computer program stored in the non-volatile memory 44, while marking use of the volatile memory 47.

The validation method begins when the traceability device 6 transmits a validation message M3 containing the data contained in its non-volatile memory 64 to the validation device 4 (naturally with the exception of its own private key Private_Object). This transmission may take place automatically in the event of the communication units 61 and 41 mutually detecting each other, or in response to a command from an operator.

Thus, in step S10, the validation device 4 receives the following data:
the key Public_Object;
the signature Signature (A, Public_Object);
the fingerprint Fingerprintₙ; and
a record m for m lying in the range 1 to n, and containing: DATAₘ, Public_Eᵢ, Signature (A, Public_Eᵢ), Signature_Eₘ, and Signature_Oₘ.

Thereafter, in step S11, the validation device 4 verifies the authenticity of Public_Object with the help of Signature (A, Public_Object). As explained above, the validation device 4 can make use of the public key Public_A and Public_Object to verify that Signature (A, Public Object) was indeed signed by the trusted authority 3.

If it is found that Public Object is authentic, the validation device 4 initializes a counter m with 1 (step S12) to enable the following steps S13 to S16 to be performed in iterative manner.

In step S13, the validation device 4 verifies the authenticity of Public_Eᵢ with the help of Signature (A, Public_Eᵢ). In similar manner to step S11, the validation device 4 can use Public_A and Public_Eᵢ to verify that Signature (A, Public_Eᵢ) was indeed signed by the trusted authority 3.

In similar manner, in step S14, the validation device 4 verifies the authenticity of Signature_Eₘ with the help of Tₘ₋₁ (an extract of predetermined size from the theoretical fingerprint Fingerprintₘ₋₁^{th} described below), of DATAₘ, and of Public_Eᵢ. More precisely, the validation device 4 uses Public_Eᵢ, Tₘ₋₁, and DATAₘ, to verify that Signature_Eₘ was indeed signed by the marking device 7ᵢ.

Thereafter, in step S15, the validation device 4 verifies the authenticity of Signature_Oₘ with the help of and Signature_Eₘ and of Public_Object. The validation device 4 thus uses Signature_Eₘ and Public_Object to verify that Signature_Oₘ was indeed signed by the traceability device 6.

Finally, in step S16, the validation device 4 determines the theoretical fingerprint Fingerprintₘ^{th}:

Fingerprintₘ^{th}=H(Fingerprintₘ₋₁^{th}, Signature_Oₘ)

If any one of the tests of steps S11 and S13 to S15 fails, that means that the data is not authentic and has been corrupted. The value of the counter m indicates the step at which the data was corrupted. The validation method terminates by issuing a data invalid message, which message may specify the value of m (step S21).

Otherwise, if the above-mentioned tests are successful, the validation device 4 acts in a step S17 to compare the counter m with n.

If m is not equal to n, that means that the steps S13 to S16 have not yet been performed for all of the steps to which the object 2 has been subjected. Under such circumstances, the counter m is incremented by unity (step S18) and the steps S13 to S16 are repeated.

Otherwise, if m is equal to n, that means that the steps S13 to S16 have been performed for all of the steps to which the object 2 has been subjected. In other words, the validation device 4 has reproduced in theoretical manner the calculation of the successive fingerprints.

Thus, in step S19, the validation device 4 compares the last theoretical fingerprint Fingerprintₙ^{th} as determined in step S16 while m was equal to n with the fingerprint Fingerprintₙ as received in step S10.

If they match, that means that the object 2 has indeed been subjected to the specified process and that the data has not been corrupted. Under such circumstances, the validation method terminates in step S20 by issuing a data valid message.

Otherwise, if Fingerprintₙ^{th} does not match Fingerprintₙ, that means that the object 2 has not followed the specified process and/or that the data has been corrupted. Under such circumstances, the validation method terminates by issuing a data invalid message (step S21).

In an implementation, in order to guard against possible cloning of the object 2, the validation device 4 authenticates the object 2 relative to holding the private key Private_Object associated with the public key Public_Object. For example, the validation device 4 asks the traceability device 6 to sign a random number referred to as a Challenge and verifies the authenticity of the signature.

Thus, by calculating successive signatures Signatureₙ it is possible to implement a cryptographic chain that guarantees the integrity of the object 2 chaining the steps Eⱼ and of the data DATAₙ transmitted to the object 2 at each step Eⱼ. The object 2 stores all of the information necessary for any validation device 4 in possession of the public key of the trusted authority A to verify locally the chaining of the step Eⱼ, to authenticate each of those steps, and to guarantee the integrity of the data transmitted at each of those steps. The validation device 4 does not to know the private key of the traceability device 6. By making use of an asymmetric key mechanism, the invention makes it possible to avoid the difficulties associated with distributing symmetric private keys.

1. A tracing method performed by a traceability device for validating a process made up of a plurality of steps, the tracing method comprising:
during at least one step of the process:
a step of receiving a marking message sent by a marking device; and
a step of determining a new fingerprint as a function of said marking message and of a preceding fingerprint, by using a hash function; and
a step of sending a validation message including the most recently determined new fingerprint to a validation device;
wherein, during said at least one step of the process, said tracing method comprises a step of determining an object signature as a function of said marking message by using an asymmetric signature function and a private key of the traceability device associated with a public key of the traceability device, with the step of determining a new fingerprint comprising determining the new fingerprint as a function of said object signature.

2. A tracing method according to claim 1, wherein the marking message comprises a step public key and a signature of said step public key as performed by a trusted entity, the method including a step of storing said step public key and said signature of said step public key, the validation message including said step public key and said signature of said step public key as stored.

3. A tracing method according to claim 1, comprising, during at least one step of the process, a step of sending an information message including at least a portion of the most recently determined new fingerprint to the marking device;
the marking device being suitable for determining a step signature as a function of said portion by using an asymmetric signature function and a private key of the marking device associated with a public key of the marking device;
said object signature being determined as a function of said step signature.

4. A tracing method according to claim 1, having an initialization step including determining an initial fingerprint (Fingerprint₀) independently of the private key of the traceability device.

5. A validation method performed by a validation device for validating a process made up of a plurality of steps, the validation method comprising:
a step of receiving a validation message sent by a traceability device, and including a fingerprint determined by the traceability device;
a step of determining a theoretical fingerprint; and
a step of comparing the fingerprint determined by the traceability device with the theoretical fingerprint;
wherein:
said validation message comprises an object signature for at least one step of the process;
the validation method including a step of verifying the authenticity of said object signature as a function of a public key of said traceability device; and
the step of determining a theoretical fingerprint comprising, when said object signature is authentic, determining a new current theoretical fingerprint as a function of a preceding theoretical fingerprint and of said object signature.

6. A validation method according to claim 5, wherein the validation message includes a step public key associated with a marking device and a step public key signature, the validation method including a step of verifying the authenticity of said step public key.

7. A validation method according to claim 6, wherein said validation message includes a step signature for at least one step (Eᵢ) of the process;
the validation method including a step of verifying the authenticity of said step signature as a function at least of said step public key; and
the step of verifying the authenticity of said object signature being performed as a function of said step signature.

8. A validation method according to claim 7, wherein said validation message includes step data for at least one step of the process, the step of verifying the authenticity of said step signature being performed as a function of said step data.

9. A validation method according to claim 5, wherein the validation message includes said public key of the traceability device and a signature of said public key of the traceability device as provided by a trusted authority, said validation method including a step of verifying the authenticity of said public key of the traceability device.

10. A validation method according to claim 5, having an initialization step including determining an initial fingerprint independently of a private key of the traceability device.

11. A marking method performed by a marking device associated with a step of a process made up of a plurality of steps, the marking method including a step of sending a marking message to a traceability device, and a step of determining a step signature by using an asymmetric signature function and a private key of the marking device associated with a public key of the marking device; and
said marking message including said step signature.

12. A marking method according to claim 11, wherein said marking message includes step data, said step signature being determined as a function at least of the step data.

13. A computer program including instructions for executing steps of the tracing method according to clam 1, or the validation method according to claim 5, or a marking method according to claim 11, when said program is executed by a computer.

14. A computer-readable storage medium having a computer program according to claim 13 stored thereon.

15. A traceability device for validating a process made up of a plurality of steps, the traceability device comprising:
means for receiving a marking message sent by a marking device during at least one step of the process;
means for determining a new fingerprint as a function of said marking message and of a preceding fingerprint by using a hash function (H) during at least one step of the process; and
means for sending a validation message including the most recently determined new fingerprint to a validation device; and
means for determining an object signature as a function of said marking message during at least one step of the process, by using an asymmetric signature function and a private key of the traceability device associated with a public key of the traceability device, said means for determining a new fingerprint being configured to determine the new fingerprint as a function of said object signature.

16. A validation device for validating a process made up of a plurality of steps, the validation device comprising:
means for receiving a validation message sent by a traceability device and including a fingerprint determined by the traceability device;
means for determining a theoretical fingerprint; and
means for comparing the fingerprint determined by the traceability device with the theoretical fingerprint;
wherein:
said validation message includes an object signature for at least one step of the process;
the validation device includes means for verifying the authenticity of said object signature as a function of a public key of said traceability device; and
said means for determining a theoretical fingerprint are configured, when said object signature is authentic, to determine a new current theoretical fingerprint as a function of a preceding theoretical fingerprint and of said object signature.

17. A marking device associated with a step of a process made up of a plurality of steps, the marking device including means for sending a marking message to a traceability device, and means for determining a step signature by using an asymmetric signature function and a private key of the marking device associated with a public key of the marking device, said marking message including said step signature.
